(19) United States
(12) Patent Application Publication
(10) Pub. No.: US 2015/0302550 A1
(43) Pub. Date: Oct. 22, 2015

(54) IMAGE GENERATION SYSTEM

(71) Applicant: Erkan Okuyan, Ankara (TR)

(72) Inventor: Erkan Okuyan, Ankara (TR)

(73) Assignee: ASELSAN ELEKTRONIK SANAYI VE TICARET ANONIM SIRKETI, Ankara (TR)

(21) Appl. No.: 14/370,956

(22) PCT Filed: Jan. 6, 2012
(86) PCT No.: PCT/IB2012/050086

§ 371 Date: Aug. 11, 2014

(51) Int. Cl. G06T 3/00; G06T 15/20

(52) U.S. Cl. CPC G06T 3/0031; G06T 15/20

(57) ABSTRACT

The present invention relates to an image generation system, which controls a set of generators and thereby allows rendering two dimensional images from a three dimensional environment, and wherein communication between the host and the generator is established. This system essentially comprises at least one host device (shortly host) which produces messages containing data related to the three dimensional synthetic environment such as optic parameters, position of moving entities, orientation of moving entities, position of viewpoint, orientation of viewpoint, material properties of entities and terrain; at least one interface which partially or totally modifies the data provided by the host device so that they define the two dimensional images whose sum may represent a part of or all of the said three dimensional synthetic environment; at least one generator which produces two dimensional representation of the three dimensional synthetic environment in accordance with the data modified by the interface.

### FIELD OF THE INVENTION

The present invention relates to an image generation system that allows to render two dimensional images from a three dimensional environment.

### BACKGROUND OF THE INVENTION

Visual simulation can be defined as production of a realistic graphical representation for user to interact with a certain environment. One specific case of visual simulation is the production of images from a three dimensional environment which is called scene generation. Scene generators work much like a computer game in which there is a three dimensional synthetic environment and many images are created for the user to view them on the computer monitor. Graphics processors are employed for effective and fast production of these images.

Scene generators are usually comprised of two main components, namely host device (shortly host) and image generator (shortly generator). Host device is the component that controls the image generator. Image generator is the component that is the workhorse of the scene generator. This component produces the graphical representation of the three dimensional environment in accordance with the commands of the host device.

Communication between the host and the generator has to be established for correct execution of the system. This can be realized in two ways: implementing the host and the generator as a single computer application or implementing a communication line between the host and the generator via network, shared memory, etc. Then the host can control the generator by accepting input from the user or in an automated fashion.

However, instead of producing a single image by using a host and a generator, there may be computer applications which require synchronized production of multiple images each different from one another by using a host and a set of generators. In this case, production of the image in a parallel and synchronized fashion poses a technical problem.

The Canadian patent document no. CA2676050, known in the state of the art, discloses parallel graphics rendering systems, and methods supporting task-based object division. The said patent document includes division of the task of generating a single image into parts and forming the image upon sending these divided parts to different generators.

### SUMMARY OF THE INVENTION

The objective of the present invention is to provide an image generation system that allows rendering two dimensional images from three dimensional environment.

Another objective of the invention is to provide an image generation system which enables the generators to be operated in a parallel fashion under the control of a single host and to produce images in a synchronized fashion.

A further objective of the invention is to provide an image generation system which turns the hosts (especially closed source hosts) that do not have the necessary interface for accepting input from outside into hosts that accept input from outside, without changing the internal operation of the host.

Another objective of the invention is to provide an image generation system in which, during successive image generation, image generation parameters are updated according to the results obtained upon processing of the generated image.

### DETAILED DESCRIPTION OF THE INVENTION

An image generation system developed to fulfill the objective of the present invention is illustrated in the accompanying figures, in which,

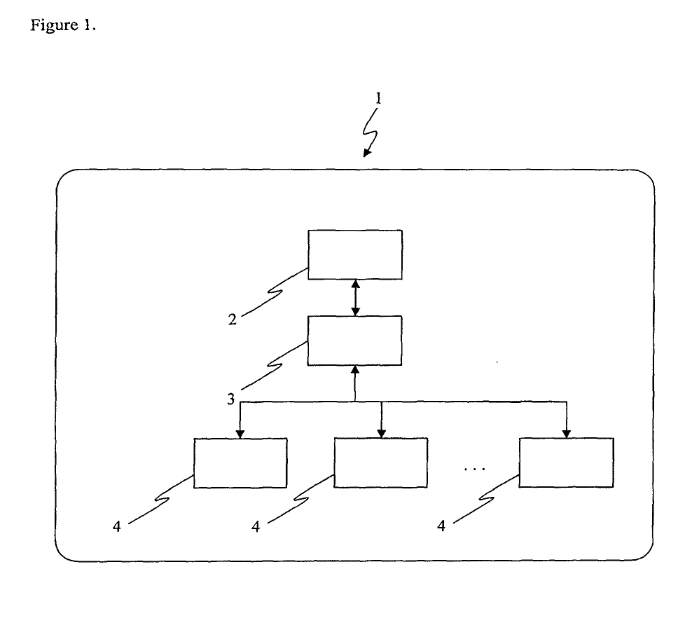

FIG. 1 is the schematic view of one embodiment of the image generation system.

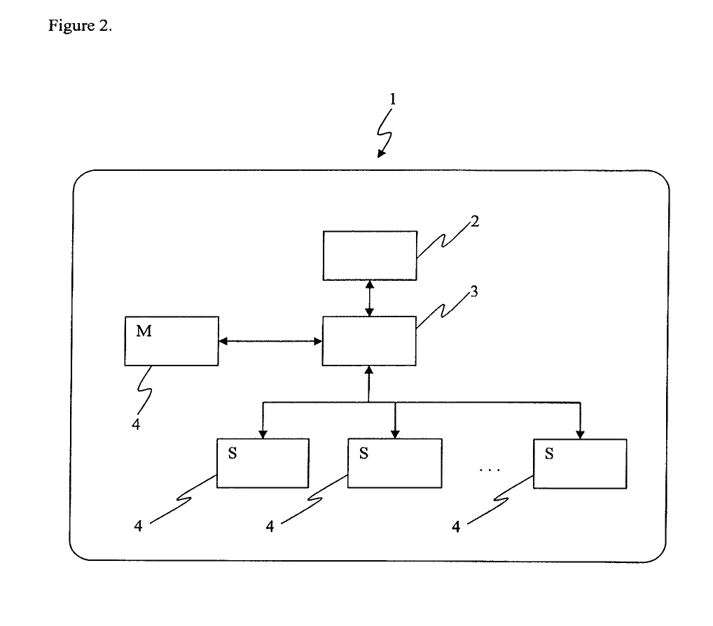

FIG. 2 is the schematic view of another embodiment of the image generation system.

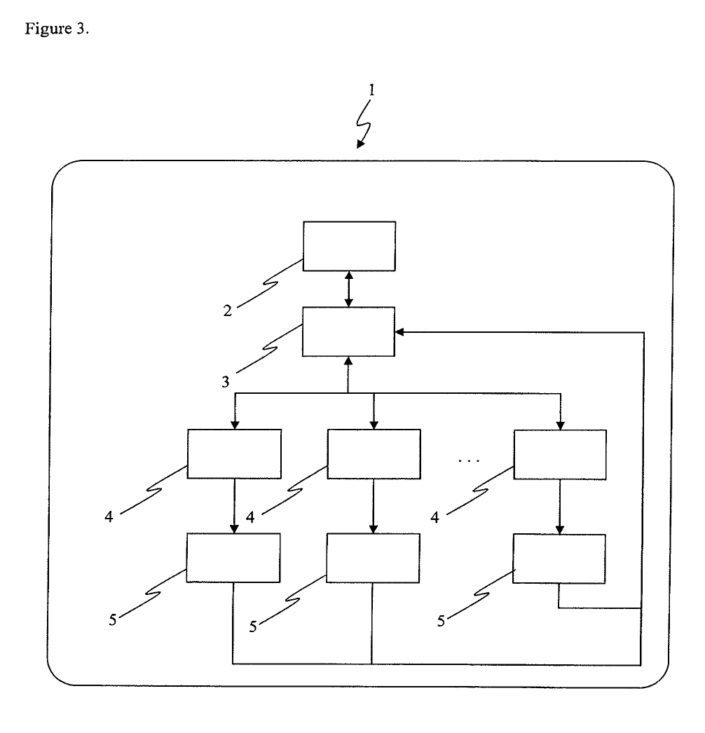

FIG. 3 is the schematic view of another embodiment of the image generation system.

The components shown in the figures are each given reference numerals as follows:
1. Image generation system
2. Host device
3. Interface
4. Generator
5. Image processing unit

The inventive image generation system (1) comprises
at least one host device (shortly host) (2) which produces messages containing data related to the three dimensional synthetic environment such as optic parameters, position of moving entities, orientation of moving entities, position of viewpoint, orientation of viewpoint, material properties of entities and terrain, etc.
at least one interface (3) which partially or totally modifies the messages provided by the host device (2) so that they define the two dimensional images whose sum may represent a part of or all of the said three dimensional synthetic environment,
at least one generator (4) which produces two dimensional representation of the three dimensional synthetic environment in accordance with the messages modified by the interface (3),
at least one image processing unit (5) which processes images produced by the generator (4) and enables to determine properties such as position, movement vector, etc. of the objects of interest in these images.

In the image generation method (1) of the present invention, the host (2) produces messages containing data related to the three dimensional synthetic environment such as optic parameters, position of moving entities, orientation of moving entities, position of viewpoint, orientation of viewpoint, material properties of entities and terrain, etc. and transmits these messages to the interface (3). Different data, exemplified above, used to define an image are also referred to as data array. The interface (3) modifies messages coming from the host (2), according to the number and properties of the generators (4) that it controls and according to the need, and forms a message set from the differing data arrays. Then, the interface (3) sends each message in the message set to a different generator (4). Each generator (4) processes the three dimensional synthetic environment in accordance with the data received from the interface (3) and produces two dimensional representation which corresponds to the data transmitted thereto. In this embodiment, operation parameter of each generator (4) is determined by the interface (3) in accordance with the parameters produced by the host (2). This way, each generator (4) operates using different parameters. The images produced by the generator (4) are then transferred to the image processing unit (5). The image processing unit (5) processes the images that it receives and determines the properties such as position, movement vector, etc. of the objects of interest in these images. After the image processing unit (5) processes the images, the interface (3) updates the image generation parameters produced by the host (2) in accordance with the results of the image processing unit (5).

In the inventive image generation system (1), the interface (3) behaves like a host (2) to the generators (4) and like a generator (4) to the host (2). That is to say, the generators (4) process the data transmitted by the interface (3) as if they are sent directly by the host (2) while the host (2) processes the data transmitted by the interface (3) as if they are directly sent by the generators (4).

In one embodiment of the invention, the inventive image generation system (1) comprises at least two generators (4), at least one which is the master generator (denoted with M in the figures) and at least one which is a slave generator (4) (denoted with S in the figures). In this embodiment, messages sent by the master generator (4) are transmitted by the interface (3) to the host (2), whereas messages sent by the slave generators (4) are discarded by the interface (3). In this embodiment, messages required to be processed by the generators (4) are transferred to these generators (4) by the interface (3). However, only the messages produced by the master generator (4) are transferred to the host (2). In this embodiment, the entire communication between the host (2) and the generators (4) is realized via the interface (3). In this embodiment, synchronized operation of the generators (4) with respect to each other is enabled by the synchronization signals produced by the master generator (4) and transmitted by the interface (3). These signals are preferably in the format of packets such as network packets, shared memory packets, etc. which are produced by the generator (4) to be sent to the host (2). These signals are communicated to the host (2) to indicate that generation of the image is about to be completed and that the generation parameters for the new image should be sent. Synchronization between the generators (4) is only ensured by transmission of the synchronization signals coming from the master generator (4) to the host (2), thus, message communication from the host (2) to the generators (4) is realized in a synchronized fashion by the signal of the master generator (4).

Messages which are modified by the interface (3) and transmitted to the generators (4) may contain data such as optic parameters, position of moving entities, orientation of moving entities, position of viewpoint, orientation of viewpoint, material properties of entities and terrain, but are not limited to them. Modification of the said messages for each generator (4) to which they will be transmitted enables each generator (4) to produce different images. For example, modification of the orientation of viewpoint in a synthetic three dimensional environment where the horizon line can be seen, enables a generator (4) to produce a field of view including the horizon line, while enabling another generator (4) to produce a field of view including the sky and another generator (4) to produce a field of view including the earth.

In the preferred embodiment of the invention, parameters to be transmitted from the host device (2) to the generators (4) are updated by the interface (3) in accordance with the outputs generated by the image processing unit (5). In other words, during successive image generation, image generation parameters are updated according to the results obtained upon processing of the generated image.

It is possible to develop various embodiments of the inventive image generation system (1). The invention can not be limited to the examples described herein and it is essentially as defined in the claims.

1-6. (canceled)

7. An image generation system (1) comprising:
at least one host device (shortly host) (2) Which produces messages containing data related to the three dimensional synthetic environment such as optic parameters, position of moving entities, orientation of moving entities, position of viewpoint, orientation of viewpoint, material properties of entities and terrain;
at least one interface (3) which partially or totally modifies the messages provided by the host device (2) so that they define the two dimensional images whose sum may represent a part of or all of the said three dimensional synthetic environment; and
at least one generator (4) which produces two dimensional representation of the three dimensional synthetic environment in accordance with the messages modified by the interface (3).

8. The image generation system (1) according to claim 7, wherein a master generator (4) messages are transmitted by the interface (3) to the host (2), and at least one slave generator (4) messages are not transmitted by the interface (3) to the host (2).

9. The image generation system (1) according to claim 7 wherein the master generator (4) produces a plurality of synchronization signals to enable synchronized operation of the generators (4) with respect to each other and the plurality of signals are transmitted by the interface (3).

10. The image generation system (1) according to claim 8 wherein the master generator (4) produces a plurality of synchronization signals to enable synchronized operation of the generators (4) with respect to each other and the plurality of signals are transmitted by the interface (3).

11. The image generation system (1) according to claim 7 wherein the interface (3) behaves like a generator (4) to the host (2) and like a host (2) to the generators (4).

12. The image generation system (1) according to claim 8 wherein the interface (3) behaves like a generator (4) to the host (2) and like a host (2) to the generators (4).

13. The image generation system (1) according to claim 9 wherein the interface (3) behaves like a generator (4) to the host (2) and like a host (2) to the generators (4).

14. The image generation system (1) according to claim 10 wherein the interface (3) behaves like a generator (4) to the host (2) and like a host (2) to the generators (4).

15. The image generation system (1) according to claim 7 wherein at least one image processing unit (5) processes images produced by the generator (4) and enables to determine properties such as position, movement vector, etc. of the objects of interest in these images.

16. The image generation system (1) according to claim 8 wherein at least one image processing unit (5) processes images produced by the generator (4) and enables to determine properties such as position, movement vector, etc. of the objects of interest in these images.

17. The image generation system (1) according to claim 9 wherein at least one image processing unit (5) processes images produced by the generator (4) and enables to determine properties such as position, movement vector, etc. of the objects of interest in these images.

18. The image generation system (1) according to claim 10 wherein at least one image processing unit (5) processes images produced by the generator (4) and enables to determine properties such as position, movement vector, etc. of the objects of interest in these images.

19. The image generation system (1) according to claim 11 wherein at least one image processing unit (5) processes images produced by the generator (4) and enables to determine properties such as position, movement vector, etc. of the objects of interest in these images.

20. The image generation system (1) according to claim 12 wherein at least one image processing unit (5) processes images produced by the generator (4) and enables to determine properties such as position, movement vector, etc. of the objects of interest in these images.

21. The image generation system (1) according to claim 13 wherein at least one image processing unit (5) processes images produced by the generator (4) and enables to determine properties such as position, movement vector, etc. of the objects of interest in these images.

22. The image generation system (1) according to claim 14 wherein at least one image processing unit (5) processes images produced by the generator (4) and enables to determine properties such as position, movement vector, etc. of the objects of interest in these images.

23. The image generation system (1) according to claim 7 wherein the interface (3) updates the parameters that are generated by and will be transmitted from the host device (2) to the generators (4) in accordance with the outputs generated by the image processing unit (5).

24. The image generation system (1) according to claim 8 wherein the interface (3) updates the parameters that are generated by and will be transmitted from the host device (2) to the generators (4) in accordance with the outputs generated by the image processing unit (5).

25. The image generation system (1) according to claim 9 wherein the interface (3) updates the parameters that are generated by and will be transmitted from the host device (2) to the generators (4) in accordance with the outputs generated by the image processing unit (5).

26. The image generation system (1) according to claim 10 wherein the interface (3) updates the parameters that are generated by and will be transmitted from the host device (2) to the generators (4) in accordance with the outputs generated by the image processing unit (5).

27. The image generation system (1) according to claim 11 wherein the interface (3) updates the parameters that are generated by and will be transmitted from the host device (2) to the generators (4) in accordance with the outputs generated by the image processing unit (5).

28. The image generation system (1) according to claim 12 wherein the interface (3) updates the parameters that are generated by and will be transmitted from the host device (2) to the generators (4) in accordance with the outputs generated by the image processing unit (5).

29. The image generation system (1) according to claim 13 wherein the interface (3) updates the parameters that are generated by and will be transmitted from the host device (2) to the generators (4) in accordance with the outputs generated by the image processing unit (5).

30. The image generation system (1) according to claim 14 wherein the interface (3) updates the parameters that are generated by and will be transmitted from the host device (2) to the generators (4) in accordance with the outputs generated by the image processing unit (5).

31. The image generation system (1) according to claim 15 wherein the interface (3) updates the parameters that are generated by and will be transmitted from the host device (2) to the generators (4) in accordance with the outputs generated by the image processing unit (5).

32. The image generation system (1) according to claim 16 wherein the interface (3) updates the parameters that are generated by and will he transmitted from the host device (2) to the generators (4) in accordance with the outputs generated by the image processing unit (5).

33. The image generation system (1) according to claim 17 wherein the interface (3) updates the parameters that are generated by and will he transmitted from the host device (2) to the generators (4) in accordance with the outputs generated by the image processing unit (5).

34. The image generation system (1) according to claim 1$ wherein the interface (3) updates the parameters that are generated by and will be transmitted from the host device (2) to the generators (4) in accordance with the outputs generated by the image processing unit (5).

35. The image generation system (1) according to claim 19 wherein the interface (3) updates the parameters that are generated by and will be transmitted from the host device (2) to the generators (4) in accordance with the outputs generated by the image processing unit (5).

36. The image generation system (1) according to claim 20 wherein the interface (3) updates the parameters that are generated by and will be transmitted from the host device (2) to the generators (4) in accordance with the outputs generated by the image processing unit (5).

37. The image generation system (1) according to claim 21 wherein the interface (3) updates the parameters that are generated by and will be transmitted from the host device (2) to the generators (4) in accordance with the outputs generated by the image processing unit (5).

38. The image generation system (1) according to claim 22 wherein the interface (3) updates the parameters that are generated by and will be transmitted from the host device (2) to the generators (4) in accordance with the outputs generated by the image processing unit (5).
